(19) United States
(12) Patent Application Publication
(10) Pub. No.: US 2023/0102585 A1
(43) Pub. Date: Mar. 30, 2023

(54) PRODUCTION METHOD FOR FIBER MOLDED BODY

(71) Applicant: TOYOTA BOSHOKU KABUSHIKI KAISHA, Aichi-ken (JP)

(72) Inventors: Ryusuke KIMURA, Ichinomiya-shi (JP); Yoshimune HABA, Nagoya-shi (JP)

(73) Assignee: TOYOTA BOSHOKU KABUSHIKI KAISHA, Aichi-ken (JP)

(21) Appl. No.: 17/910,140

(22) PCT Filed: Feb. 25, 2021
(86) PCT No.: PCT/JP2021/007039

§ 371 Date: Sep. 8, 2022

(30) Foreign Application Priority Data
Mar. 18, 2020 (JP) 2020-047827

(51) Int. Cl. B29C 70/46; B27N 3/04; B29C 70/18

(52) U.S. Cl. CPC B29C 70/46; B27N 3/04; B29C 70/18; B29C 2793/0027; B29C 2793/009; B29K 2267/00

(57) ABSTRACT

A method for manufacturing a fiber formed body includes forming a fiber board into a predetermined outer shape while forming a pattern on an outer surface of the fiber board by compressing the fiber board, a forming at least one positioning member by compressing the fiber board, and positioning, relative to a cutoff device, the fiber board using the positioning member, and cutting off a cutoff target part of the fiber board using the cutoff device. In the method for manufacturing the fiber formed body, formation of the pattern during the forming of the outer shape and formation of the positioning member during the forming of the positioning member are simultaneously performed.

### TECHNICAL FIELD

The present disclosure relates to a method for manufacturing a fiber formed body formed by compressing a fiber material.

### BACKGROUND ART

Patent Literature 1 discloses, as the above-described fiber formed body, an example of an intake duct for an internal combustion engine that is formed by compressing a nonwoven fabric containing thermoplastic resin binder. The intake duct has a peripheral wall that includes high-compression portions, each having a relatively high compressibility, and low-compression portions, each having a relatively low compressibility. The surface of the intake duct includes an uneven pattern that is formed by the high-compression portions and the low-compression portions.

Such a fiber formed body is formed, for example, as follows. First, an outer shape forming step is performed for compressing a fiber board made of a fiber material (nonwoven fabric) so as to form the fiber board of which the outer surface has a pattern. Then, a cutoff step is performed so that an unnecessary part of the fiber board is cut off using a cutoff device.

### CITATION LIST

### Patent Literature

Patent Literature 1: Japanese Laid-Open Patent Publication No. 2018-178904

### SUMMARY OF INVENTION

### Technical Problem

The fiber board compressed in the outer shape forming step shrinks and deforms when having a decreased temperature subsequent to the compression. The fiber board made of a fiber material has properties in which the manners of deformation vary to a large extent in such shrinkage and deformation. Thus, when the unnecessary part of the fiber board is cut off in the cutoff step so as to form the fiber formed body, variations tend to occur in the relative position of the part of the fiber board on which a pattern is formed and the part that is cut off by the cutoff device. Such variations in the relative position may lower the accuracy in forming the fiber formed body.

It is an objective of the present invention to provide a method for manufacturing a fiber formed body capable of highly accurately forming a fiber formed body of which the outer surface has a pattern.

### Solution to Problem

A method for manufacturing a fiber formed body that solves the above-described problem is a method for manufacturing a fiber formed body that has an outer surface with a pattern and is formed by compressing a fiber material. The method includes an outer shape forming step that forms a fiber board made of the fiber material into a predetermined outer shape while forming the pattern on an outer surface of the fiber board by compressing the fiber board, a positioning member forming step that forms at least one positioning member by compressing the fiber board, the at least one positioning member having an uneven shape on the outer surface of the fiber board and being used to position the fiber board, and a cutoff step that positions, relative to a cutoff device, the fiber board including the pattern and the positioning member using the positioning member and cuts off a cutoff target part of the fiber board using the cutoff device. Formation of the pattern in the outer shape forming step and formation of the positioning member in the positioning member forming step are simultaneously performed.

In the manufacturing method, the pattern and the positioning member are simultaneously formed on the outer surface of the fiber board. Thus, one of the part of the fiber board where the pattern is formed and the part of the fiber board where the positioning member is formed is prevented from shrinking and deforming to a larger degree than the other one. This limits variations in the relative positions of the pattern and the positioning member that would result from the difference in shrinkage degree of each component of the fiber board. Thus, the patterned portion of the fiber board is accurately arranged on the cutoff device using the positioning member of the fiber board. Accordingly, the unnecessary part of the fiber board is precisely cut off using the cutting device such that the pattern is located at a proper position of the fiber formed body. This allows for highly accurate formation of the fiber formed body having the outer surface with the pattern.

### BRIEF DESCRIPTION OF DRAWINGS

FIG. 1 is a perspective view of a fiber formed body to which a manufacturing method according to an embodiment is applied.

FIG. 2 is a cross-sectional view of the fiber formed body, taken along line 2-2 in FIG. 1.

FIG. 3 is a cross-sectional view of the fiber formed body, taken along line 3-3 in FIG. 1.

FIG. 4 is a flowchart showing the steps of manufacturing the fiber formed body.

FIG. 5 is a diagram illustrating a first step.

FIG. 6 is a diagram illustrating a second step.

FIG. 7 is a diagram illustrating a third step.

FIG. 8 is a perspective view of a fiber formed body according to a modification.

FIG. 9 is a perspective view of a fiber formed body according to another modification.

### DESCRIPTION OF EMBODIMENTS

A method for manufacturing a fiber formed body according to an embodiment will now be described.

First, the fiber formed body to which the manufacturing method of the present embodiment is applied will be described.

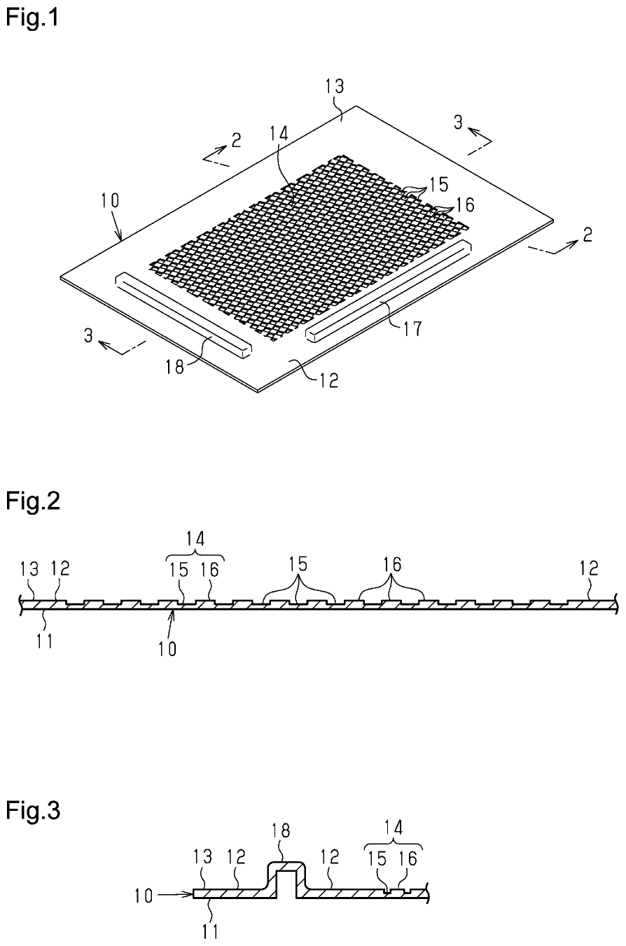

As shown in FIG. 1, the outer shape of a fiber formed body 10 is rectangular and substantially flat. The fiber formed body 10 is made of a compressed fiber material (nonwoven fabric). The nonwoven fabric of the fiber formed body 10 is made of fiber containing, for example, polyethylene terephthalate (PET).

The fiber formed body 10 includes a base 12 and a patterned portion 14. The base 12 includes an outer edge of the fiber formed body 10 and has the shape of a quadrilateral frame. The patterned portion 14 is surrounded by the base 12.

As shown in FIGS. 2 and 3, one (lower surface 11) of the surfaces of the fiber formed body 10 in the thickness direction has an even shape without a step (flat shape). The part of the other surface (upper surface 13) of the fiber formed body 10 in the thickness direction corresponding to the base 12 is flat. Thus, the base 12 of the fiber formed body 10 has a flat shape with a uniform thickness.

The part of the upper surface 13 of the fiber formed body 10 corresponding to the patterned portion 14 has an uneven shape. More specifically, the patterned portion 14 includes high-compression portions 15, each having been compressed at a relatively high compressibility, and low-compression portions 16, each having been compressed at a lower compressibility than that of the high-compression portion 15. As shown in FIG. 1, the high-compression portions 15 and the low-compression portions 16 are quadrilateral such that they both have the same square shape as viewed in the thickness direction of the fiber formed body 10. The high-compression portions 15 and the low-compression portions 16 are alternately laid out in the directions of the opposite sides of the squares. As shown in FIG. 2, the high-compression portion 15 is thinner than the low-compression portion 16. The high-compression portion 15 and the low-compression portion 16 are continuous with each other by a step at the part of the upper surface 13 of the fiber formed body 10 corresponding to the patterned portion 14.

As shown in FIGS. 1 and 3, the base 12 of the fiber formed body 10 includes positioning members 17, 18. The positioning members 17, 18 are protrusions each having a U-shaped cross-section. The positioning members 17, 18 extend along the outer edge of the patterned portion 14 between the patterned portion 14 and the outer edge of the base 12 in the fiber formed body 10. The first positioning member 17 extends in the longitudinal direction of the fiber formed body 10. The second positioning member 18 extends in the lateral direction of the fiber formed body 10. The positioning members 17, 18 are shaped to protrude from the upper surface 13 of the fiber formed body 10. The positioning members 17, 18 are used to position the fiber formed body 10 (more specifically, a fiber board 20) during manufacturing of the fiber formed body 10. The fiber board 20 will be described later.

The procedure for manufacturing the fiber formed body 10 in the present embodiment will now be described.

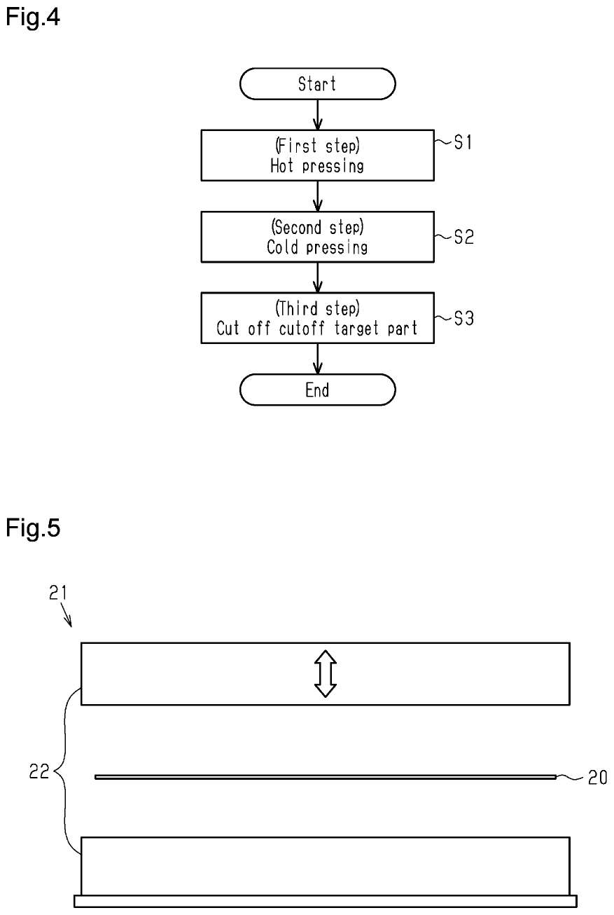

As shown in FIG. 4, a first step is first performed to manufacture the fiber formed body 10 (step S1).

In the first step, as shown in FIG. 5, a hot press machine 21 is used to perform hot pressing for the fiber board 20. The fiber board 20 is made of a nonwoven fabric having a uniform thickness. The hot press machine 21 is a press machine that includes a die apparatus 22 and a heating apparatus (not shown) that heats the die apparatus 22 using, for example, hot air. In the first step, the fiber board 20 is compressed with the fiber board 20 heated. In the present embodiment, the first step is performed to form the fiber board 20 into a rectangular flat plate.

Subsequent to the first step, a second step is performed (step S2 in FIG. 4).

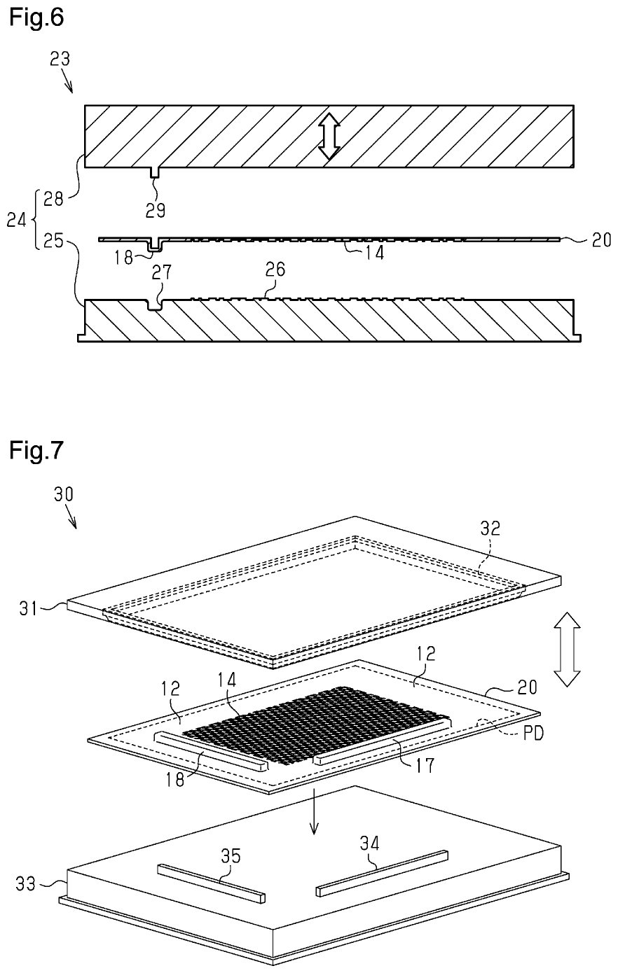

In the second step, as shown in FIG. 6, a cold press machine 23 is used to perform cold pressing for the fiber board 20.

The cold press machine 23 is a press machine that includes a die apparatus 24 and a cooling apparatus (not shown) that cools the die apparatus 24 using, for example, coolant. In the second step, the fiber board 20 is compressed with the fiber board 20 cooled. The die apparatus 24 includes a fixed die 25 and a movable die 28. The fixed die 25 includes a projection 26 that forms the patterned portion 14 and a recess 27 that forms the positioning members 17, 18. The movable die 28 includes a projection 29 that forms the positioning members 17, 18. In the second step, the cold press machine 23 including the die apparatus 24 is used to perform cold pressing for the fiber board 20 so that the patterned portion 14 and the positioning members 17, 18 are formed on the fiber board 20. In the present embodiment, in the second step, the patterned portion 14 and the positioning members 17, 18 are simultaneously formed.

The fiber board 20 formed in the second step has a middle part in the extending direction that serves as the fiber formed body 10. The quadrilateral frame of the fiber board 20 defining the outer edge in the extending direction is an unnecessary part (cutoff target part). In the present embodiment, the positioning members 17, 18 are formed on parts of the fiber board 20 other than the cutoff target part, that is, are formed on the part serving as the fiber formed body 10. In the present embodiment, the second step corresponds to a positioning member forming step that forms the positioning members 17, 18 on the fiber board 20, and the first and second steps correspond to an outer shape forming step that forms the fiber board 20 into a predetermined outer shape while forming the pattern on the outer surface of the fiber board 20.

Subsequent to the second step, a third step is performed (step S3 in FIG. 4).

In the second step, as shown in FIG. 7, a cutoff device 30 is used to cut off a cutoff target part PD of the fiber board 20.

The cutoff device 30 includes a movable die 31 and a fixed die 33. The inner surface (the lower surface in FIG. 7) of the movable die 31 includes a cutting blade 32, which is a quadrilateral looped Thomson blade. The inner surface (the upper surface in FIG. 7) of the fixed die 33 includes a first positioning projection 34 and a second positioning projection 35. On the inner surface of the fixed die 33, the first positioning projection 34 is located in correspondence with the first positioning member 17 and shaped so as to fit the first positioning member 17. On the inner surface of the fixed die 33, the second positioning projection 35 is located in correspondence with the second positioning member 18 and shaped so as to fit the second positioning member 18.

In the third step, the movable die 31 and the fixed die 33 of the cutoff device 30 are first separated from each other and made open (as shown in FIG. 7). In this state, the fiber board 20 is placed onto the fixed die 33 so as to fit the positioning projections 34, 35 into the positioning members 17, 18 of the fiber board 20, respectively. Thus, the fiber board 20 is positioned relative to the cutoff device 30 (more specifically, fixed die 33). In this state, the cutoff device 30 is locked so that the cutoff target part PD of the fiber board 20 is cut off using the cutting blade 32 of the movable die 31. In the present embodiment, the third step corresponds to a cutoff step.

In the present embodiment, the first to third steps are performed to manufacture the fiber formed body 10 (FIG. 1) of which the outer surface has a pattern.

The operation of the method for manufacturing the fiber formed body 10 in the present embodiment will now be described.

To manufacture the above-described fiber formed body 10, the temperature of the fiber formed body 10 (more specifically, fiber board 20) greatly changes such that the temperature increases in the hot pressing of the first step and decreases in the cold pressing of the second step subsequent to the first step. The fiber board 20 deforms (expands and shrinks) in correspondence with such temperature changes.

Thus, if the patterned portion 14 and the positioning members 17, 18 of the fiber board 20 are formed at different points in time, the part of the fiber board 20 where the patterned portion 14 is formed and the part of the fiber board 20 where the positioning members 17, 18 are formed would have differences in the degree of deformation of the fiber board 20 that results from subsequent temperature changes. This may vary the relative positions of the patterned portion 14 and the positioning members 17, 18.

In this case, when the positioning members 17, 18 of the fiber board 20 are used to position the fiber board 20 relative to the fixed die 25 of the cutoff device 30, variations would occur in the relative position of the patterned portion 14 of the fiber board 20 and the cutting blade 32 of the movable die 31. This lowers the accuracy in setting the position where cutting is performed by the cutting blade 32, and consequently lowers the accuracy in forming the fiber formed body 10.

In the present embodiment, the second step is performed to simultaneously form the patterned portion 14 and the positioning members 17, 18 on the outer surface of the fiber board 20. Thus, one of the part of the fiber board 20 where the patterned portion 14 is formed and the part of the fiber board 20 where the positioning members 17, 18 are formed is prevented from shrinking and deforming to a larger degree than the other one. This limits variations in the relative positions of the patterned portion 14 and the positioning members 17, 18 that would result from the difference in shrinkage degree of each component of the fiber board 20. Thus, the patterned portion 14 of the fiber board 20 is accurately arranged on the fixed die 25 of the cutoff device 30 using the positioning members 17, 18 of the fiber board 20. Accordingly, the unnecessary part of the fiber board 20 is precisely cut off using the cutting blade 32 of the movable die 28 of the cutoff device 30 such that the patterned portion 14 is located at a proper position of the fiber formed body 10. This allows for highly accurate formation of the fiber formed body 10 having the outer surface with a pattern.

If the patterned portion 14 and the positioning members 17, 18 are formed on the fiber board 20 through hot pressing, the fiber board 20 would have a high temperature when formed. Thus, the extent of shrinkage and deformation in each component of the fiber board 20 that would result from temperature decrease subsequent to the formation tends to be large. As a result, variations easily occur in the shrinkage degree of each component of the fiber board 20. This may lower the dimension accuracy and arrangement accuracy in the patterned portion 14 and the positioning members 17, 18 of the fiber board 20.

In the present embodiment, the patterned portion 14 and the positioning members 17, 18 are formed on the fiber board 20 through the cold pressing in the second step. In the present embodiment, unlike a case in which hot pressing is performed to form the patterned portion 14 and the positioning members 17, 18 on the outer surface of the fiber board 20, the fiber board 20 has a low temperature when the patterned portion 14 and the positioning members 17, 18 are formed. This limits the shrinkage and deformation of each component of the fiber board 20 subsequent to the formation of the patterned portion 14 and the positioning members 17, 18. Thus, variations in the relative positions of the patterned portion 14 and the positioning members 17, 18 that would result from the difference in shrinkage degree of each component of the fiber board 20 are limited in a favorable manner.

The above-described embodiment has the following advantages.

(1) The second step is performed to simultaneously form the patterned portion 14 and the positioning members 17, 18 on the outer surface of the fiber board 20. This allows for highly accurate formation of the fiber formed body 10 having the outer surface with a pattern.

(2) In the second step, cold pressing is performed to form the patterned portion 14 and the positioning members 17, 18 on the outer surface of the fiber board 20. Thus, variations in the relative positions of the patterned portion 14 and the positioning members 17, 18 that would result from the difference in shrinkage degree of each component of the fiber board 20 are limited in a favorable manner.

(3) Multiple positioning members 17, 18 are formed on the fiber board 20. This allows the fiber board 20 to be positioned relative to the fixed die 25 of the cutoff device 30 at multiple positions. Thus, as compared with when positioning is performed at only one position, the fiber board 20 is positioned accurately.

(4) The positioning members 17, 18 are formed on the part of the fiber board 20 that is not cut off in the third step, that is, the part of the fiber board 20 serving as the fiber formed body 10. Thus, despite the formation of the positioning members 17, 18 on the fiber board 20, the outer shape of the fiber board 20 does not need to be increased for the formation of the positioning members 17, 18. This limits enlargement of the cutoff target part PD of the fiber board 20 and thus limits a decrease in the yield of manufacturing the fiber formed body 10.

The above-described embodiment may be modified as follows. The above-described embodiment and the following modifications can be combined as long as the combined modifications remain technically consistent with each other.

The uneven shape of the patterned portion 14, that is, the pattern of the fiber formed body 10 may be changed.

The fiber board 20 may include three or more positioning members. As long as the fiber board 20 is properly positioned relative to the cutoff device 30, the fiber board 20 may include only one positioning member.

The positioning members 17, 18 may be formed on the cutoff target part PD of the fiber board 20.

As long as the positioning members 17, 18 have an uneven shape on the outer surface of the fiber board 20 and are shaped such that they can be used to position the fiber board 20, the positioning members 17, 18 may have any shape.

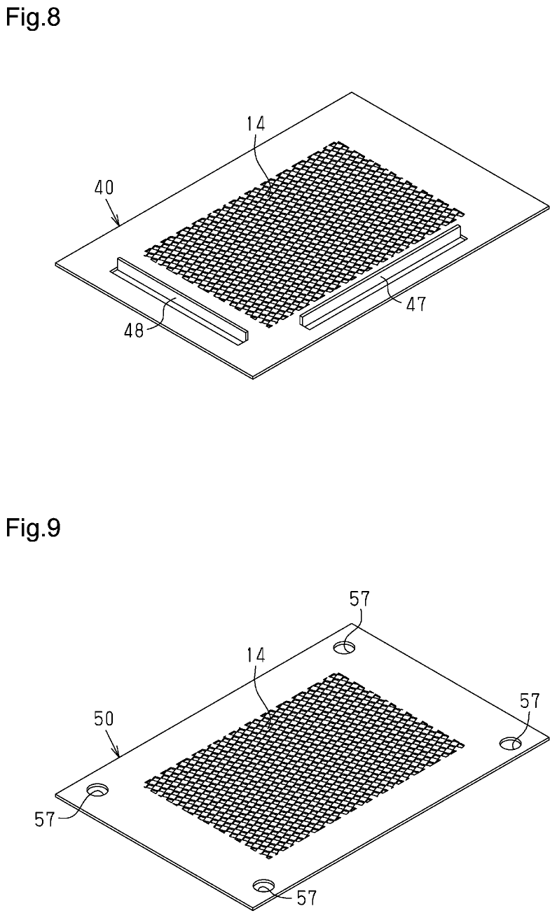

For example, a projection having a shape different from the shapes of the positioning members 17, 18 (e.g., flat shape, columnar shape, or polygonal shape) may protrude from the outer surface of the fiber board 20 as a positioning member. In an example shown in FIG. 8, the outer surface of a fiber board 40 includes a flat first positioning member 47 extending in the longitudinal direction and the thickness direction and a flat second positioning member 48 extending in the lateral direction and the thickness direction. In this case, the fixed die 33 of the cutoff device 30 (see FIG. 7) simply needs to include grooves shaped in correspondence with the protruding shapes of the positioning members 47, 48. In the third step, the fiber board 40 is positioned relative to the fixed die 33 of the cutoff device 30 by placing the fiber board 40 onto the fixed die 33 of the cutoff device 30 such that the positioning members 47, 48 of the fiber board 40 are fitted into the grooves of the fixed die 33.

Alternatively, a fiber board may include a through-hole or a recess as a positioning member. In an example shown in FIG. 9, a rectangular fiber board 50 that is substantially flat includes through-holes 57 as positioning members on four corners of the fiber board 50. In this case, protrusions shaped in correspondence with the shapes of the through-holes 57 simply need to be formed at positions that respectively correspond to the through-holes 57 in the fixed die 33 of the cutoff device 30 (see FIG. 7). In the third step, the fiber board 50 is positioned relative to the fixed die 33 of the cutoff device 30 by placing the fiber board 50 onto the fixed die 33 of the cutoff device 30 such that the projections of the fixed die 33 of the cutoff device 30 are fitted into the through-holes 57 of the fiber board 50. In the case of forming through-holes on a fiber formed body as positioning members, the through-holes can each be used as a swaged hole in a fixing structure of fixing the fiber formed body to a fixing target member through swaging.

Positioning members may be arranged on the patterned portion 14. In this case, if the fiber board 20 can be positioned, its uneven pattern (more specifically, uneven shape) may partially function as a positioning member.

The manufacturing method of the above-described embodiment may be applied to a manufacturing method in which the first step (hot pressing) and the second step (cold pressing) are performed using the same die as the die used as a series of steps (outer shape forming step). In this case, a patterned portion and a positioning member simply need to be formed on a fiber board through cold pressing in the outer shape forming step.

In the third step, the method for cutting off the cutoff target part PD of the fiber board 20 is not limited to the method for cutting and removing the cutoff target part PD using the cutting blade 32, which is a Thomson blade. Instead, the method for cutting off the cutoff target part PD may be, for example, a method for cutting and removing the cutoff target part PD using an ultrasonic cutter.

The manufacturing method of the above-described embodiment does not have to be applied to a substantially flat fiber formed body and may be applied to a fiber formed body having any shape. Examples of such a fiber formed body include a fiber formed body that includes a semicircular portion extending with a semicircular cross-section and a flat flange that protrudes from opposite ends of the semicircular portion outward in the radial direction. In this fiber formed body, when a patterned portion is formed on the outer surface of the semicircular portion and a positioning member is formed on the flange, the patterned portion and the positioning member are simultaneously formed. This limits variations in the relative position of the patterned portion and the positioning member that would result from the difference in shrinkage degree of each component of the fiber board.

### REFERENCE SIGNS LIST

10) Fiber Formed Body
13) Upper Surface
14) Patterned Portion
17, 47) First Positioning Member
18, 48) Second Positioning Member
20, 40, 50) Fiber Board
21) Hot Press Machine
23) Cold Press Machine
30) Cutoff Device
31) Movable Die
32) Cutting Blade
57) Through Hole

1. A method for manufacturing a fiber formed body that has an outer surface with a pattern and is formed by compressing a fiber material, the method comprising:
forming a fiber board made of the fiber material into a predetermined outer shape while forming the pattern on an outer surface of the fiber board by compressing the fiber board;
forming at least one positioning member by compressing the fiber board, the at least one positioning member having an uneven shape on the outer surface of the fiber board and being used to position the fiber board;
positioning, relative to a cutoff device, the fiber board including the pattern and the positioning member using the positioning member; and
cutting off, with the fiber board positioned relative to the cutoff device, a cutoff target part of the fiber board using the cutoff device,
wherein formation of the pattern and formation of the positioning member are simultaneously performed.

2. The method according to claim 1, wherein
the forming of the outer shape includes performing hot pressing for the fiber board and performing cold pressing for the fiber board subsequent to the hot pressing, and
the pattern is formed during the cold pressing.

3. The method according to claim 1, wherein
the at least one positioning member includes positioning members, and
the forming of the at least one positioning member includes forming the positioning members on the fiber board.

4. The method according to claim 1, wherein the forming of the at least one positioning member includes forming the at least one positioning member on a part of the fiber board that is not cut off during the cutting off of the cutoff target part.
